(19) United States
(12) Patent Application Publication
(10) Pub. No.: US 2008/0278951 A1
(43) Pub. Date: Nov. 13, 2008

(54) Floor lamp having overload breaker that is operated easily and conveniently

(76) Inventors: Kun-Szu Chiang, Taichung (TW); David Chaing, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/800,544

(22) Filed: May 8, 2007

(51) Int. Cl. F21V 23/04

(52) U.S. Cl. 362/295

(57) ABSTRACT

A floor lamp includes a lamp body, an electric cord, a control switch, and a breaker. The breaker is connected to the electric cord and the control switch and hidden in the lamp body. Thus, a user only needs to operate the control switch to restart the floor lamp after a power failure or an overload, so that the floor lamp is restarted easily and conveniently. In addition, the breaker is hidden in the upright tube of the lamp body so that the breaker will not be wet or dirtied and will not be worn out due to hit by a foreign object during transportation, thereby enhancing the lifetime of the breaker and the floor lamp.

### BACKGROUND OF THE INVENTION

1. Field of the Invention

The present invention relates to a lamp and, more particularly, to a floor lamp having an overload breaker.

2. Description of the Related Art

A conventional floor lamp in accordance with the prior art shown in FIG. 3 comprises a lamp body la, an electric cord 2a, and a control switch 22a. The lamp body la includes a base 11a, an upright tube 12a, a shade 13a, and at least one electric bulb 14a. The electric cord 2a is mounted in the upright tube 12a of the lamp body 1a and has a first end connected to the electric bulb 14a of the lamp body 1a and a second end protruded outwardly from the base 11a of the lamp body 1a and provided with a plug 21a. The control switch 22a is mounted on the upright tube 12a of the lamp body 1a and connected between the electric cord 2a and the electric bulb 14a of the lamp body 1a to control operation of the electric bulb 14a of the lamp body 1a. However, such a conventional floor lamp is not provided with a breaker.

Another conventional floor lamp in accordance with the prior art shown in FIG. 4 comprises a lamp body 1b, an electric cord 2b, a control switch 22b, and a breaker 3b. The lamp body 1b includes a base 11b, an upright tube 12b, a shade 13b, and at least one electric bulb 14b. The electric cord 2b is mounted in the upright tube 12b of the lamp body 1b and has a first end connected to the electric bulb 14b of the lamp body 1b and a second end protruded outwardly from the base 1 1b of the lamp body 1b and provided with a plug 21b. The control switch 22b is mounted on the upright tube 12b of the lamp body 1b. The breaker 3b is mounted on the electric cord 2b and protruded outwardly from the base 1 1b of the lamp body lb. The breaker 3b is provided with a restart button 31b. In operation, when the voltage of the floor lamp is detected to exceed a determined value, the breaker 3b automatically cuts off the electric power supplied by the plug 2 1b of the electric cord 2b to prevent the floor lamp from incurring an overload so as to achieve a safe operation of the floor lamp. However, a user needs to press the restart button 31b of the breaker 3b to restart the floor lamp after a power failure or an overload, so that the floor lamp cannot be restarted easily and conveniently, thereby causing inconvenience to the user when restarting the floor lamp. In addition, the breaker 3b is protruded outwardly from the base 1 1b of the lamp body 1b so that the breaker 3b is easily wet or dirtied and is easily worn out due to hit by a foreign object during transportation, thereby decreasing the lifetime of the breaker 3b and the floor lamp.

### BRIEF SUMMARY OF THE INVENTION

In accordance with the present invention, there is provided a floor lamp, comprising a lamp body, an electric cord, a control switch, and a breaker. The lamp body includes a base, an upright tube, a shade, and at least one electric bulb. The electric cord is mounted in the upright tube of the lamp body and has a first end connected to the electric bulb of the lamp body and a second end protruded outwardly from the base of the lamp body and provided with a plug. The control switch is mounted on the upright tube of the lamp body. The breaker is connected to the electric cord and the control switch and hidden in the upright tube of the lamp body.

The primary objective of the present invention is to provide a floor lamp having an overload breaker that is operated easily and conveniently.

Another objective of the present invention is to provide a floor lamp, wherein a user only needs to operate the control switch to restart the electric power of the floor lamp after a power failure or an overload, so that the floor lamp is restarted easily and conveniently, thereby facilitating the user restarting the floor lamp.

A further objective of the present invention is to provide a floor lamp, wherein the breaker is restarted by the control switch so that the breaker needs not to have a restart button, thereby decreasing the costs of fabrication.

A further objective of the present invention is to provide a floor lamp, wherein the breaker is hidden in the upright tube of the lamp body so that the breaker will not be wet or dirtied and will not be worn out due to hit by a foreign object during transportation, thereby enhancing the lifetime of the breaker and the floor lamp.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front broken view of a floor lamp in accordance with the preferred embodiment of the present invention.

FIG. 2 is a locally enlarged view of the floor lamp as shown in FIG. 1.

FIG. 3 is a front broken view of a conventional floor lamp in accordance with the prior art.

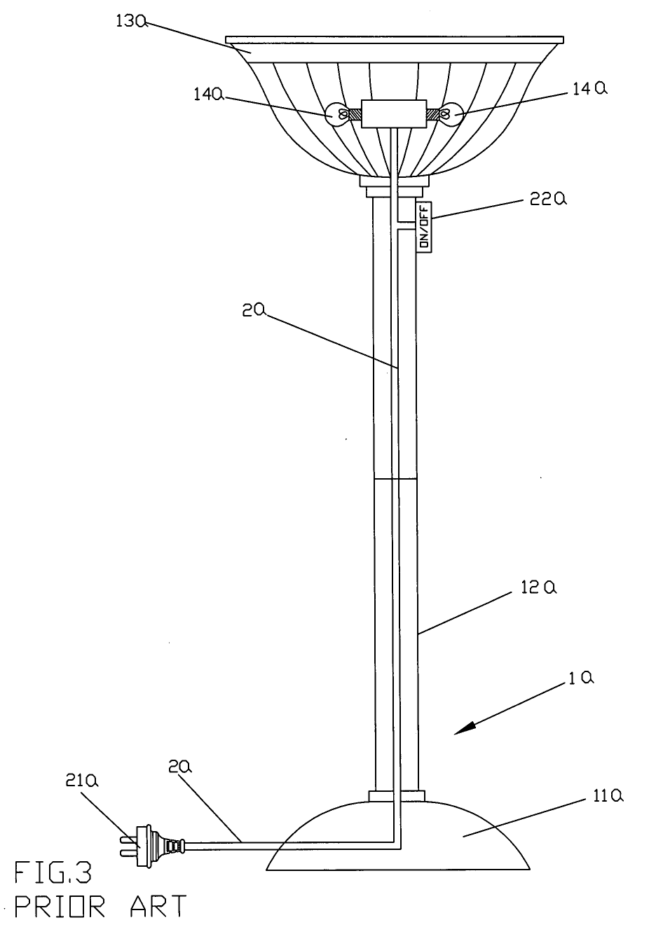

FIG. 4 is a front broken view of another conventional floor lamp in accordance with the prior art.

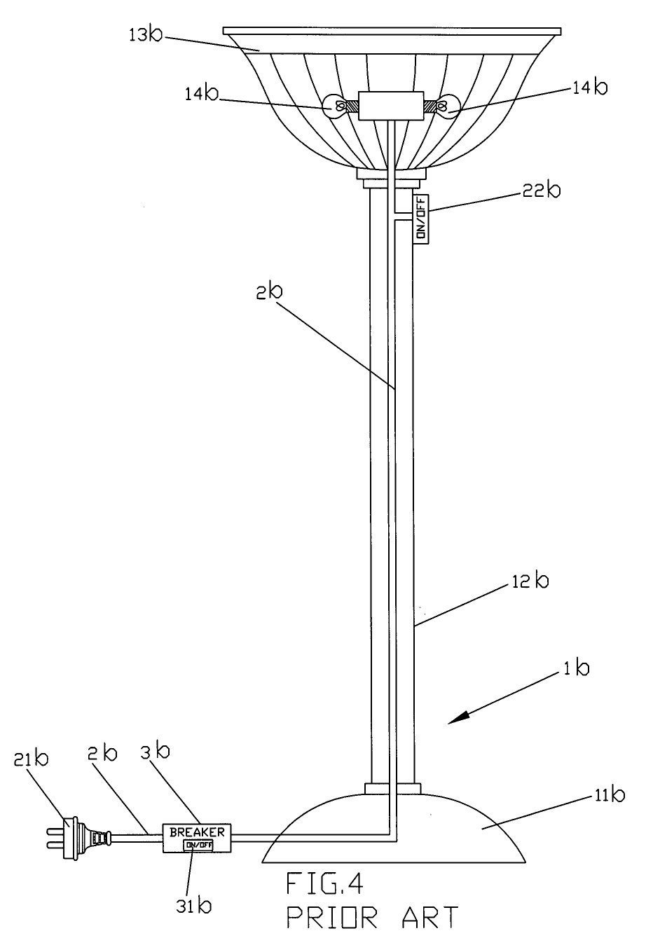

### DETAILED DESCRIPTION OF THE INVENTION

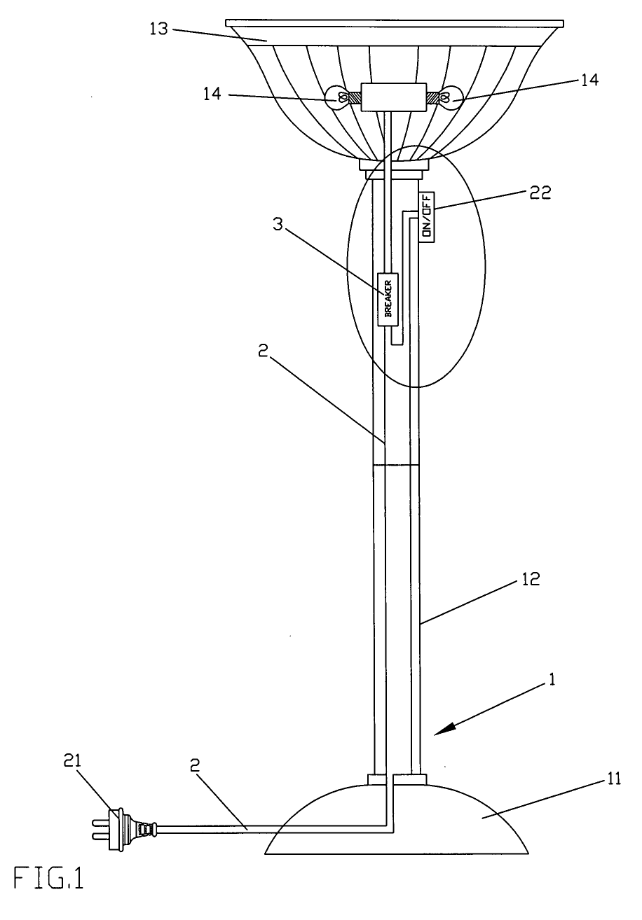

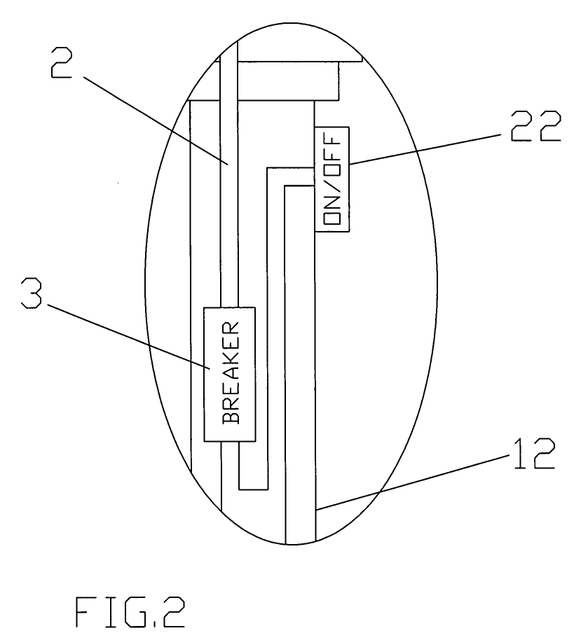

Referring to FIGS. 1 and 2, a floor lamp in accordance with the preferred embodiment of the present invention comprises a lamp body 1, an electric cord 2, a control switch 22, and a breaker 3.

The lamp body 1 includes a base 1 1, an upright tube 12, a shade 13, and at least one electric bulb 14.

The electric cord 2 is mounted in the upright tube 12 of the lamp body 1 and has a first end connected to the electric bulb 14 of the lamp body 1 and a second end protruded outwardly from the base 11 of the lamp body 1 and provided with a plug 21.

The control switch 22 is mounted on the upright tube 12 of the lamp body 1. The control switch 22 is a contact switch.

The breaker 3 is connected to the electric cord 2 and the control switch 22 and hidden in the upright tube 12 of the lamp body 1. The breaker 3 is connected with the electric cord 2 serially and has a side connected to the control switch 22. The breaker 3 is located closer to the control switch 22. The breaker 3 is connected between the electric cord 2 and the control switch 22 so that the control switch 22 is connected to the electric cord 2 by the breaker 3. Thus, the breaker 3 co-operates with the control switch 22 to function as a restart button after a power failure.

In operation, when the voltage of the floor lamp is detected to exceed a determined value, the breaker 3 automatically cuts off the electric power supplied by the plug 21 of the electric cord 2 to prevent the floor lamp from incurring an overload so as to achieve a safe operation of the floor lamp. When the control switch 22 is pressed or touched after a power failure, the breaker 3 is restarted by the control switch 22 so as to supply the electric power to the floor lamp so that the floor lamp is operated again.

Accordingly, a user only needs to operate the control switch 22 to restart the electric power of the floor lamp after a power failure or an overload, so that the floor lamp is restarted easily and conveniently, thereby facilitating the user restarting the floor lamp. In addition, the breaker 3 is restarted by the control switch 22 so that the breaker 3 needs not to have a restart button, thereby decreasing the costs of fabrication. Further, the breaker 3 is hidden in the upright tube 12 of the lamp body 1 so that the breaker 3 will not be wet or dirtied and will not be worn out due to hit by a foreign object during transportation, thereby enhancing the lifetime of the breaker 3 and the floor lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A floor lamp, comprising a lamp body, an electric cord, a control switch, and a breaker, wherein:
the lamp body includes a base, an upright tube, a shade, and at least one electric bulb;
the electric cord is mounted in the upright tube of the lamp body and has a first end connected to the electric bulb of the lamp body and a second end protruded outwardly from the base of the lamp body and provided with a plug;
the control switch is mounted on the upright tube of the lamp body;
the breaker is connected to the electric cord and the control switch and hidden in the upright tube of the lamp body.

2. The floor lamp in accordance with claim 1, wherein the breaker is connected with the electric cord serially.

3. The floor lamp in accordance with claim 1, wherein the breaker has a side connected to the control switch.

4. The floor lamp in accordance with claim 1, wherein the breaker is located closer to the control switch.

5. The floor lamp in accordance with claim 1, wherein the breaker is connected between the electric cord and the control switch so that the control switch is connected to the electric cord by the breaker.

6. The floor lamp in accordance with claim 5, wherein the breaker co-operates with the control switch to function as a restart button after a power failure.

7. The floor lamp in accordance with claim 1, wherein when the control switch is pressed after a power failure, the breaker is restarted by the control switch to supply an electric power to the floor lamp so that the floor lamp is operated again.
